(19) United States
(12) Patent Application Publication
(10) Pub. No.: US 2026/0055273 A1
(43) Pub. Date: Feb. 26, 2026

(54) FLAME-RETARDANT POLYAMIDE COMPOSITION

(71) Applicant: BASF SE, Ludwigshafen am Rhein (DE)

(72) Inventors: Dong YAN, Shanghai (CN); Mok-keun LIM, Seoul (KR); Hong Yi YUAN, Shanghai (CN)

(21) Appl. No.: 19/104,747

(22) PCT Filed: Aug. 17, 2023
(86) PCT No.: PCT/EP2023/072731

§ 371 Date: Feb. 19, 2025

(30) Foreign Application Priority Data
Aug. 22, 2022 (WO) PCT/CN2022/113957

(51) Int. Cl. C08L 77/02; C08K 3/02; C08K 3/22; C08K 7/14

(52) U.S. Cl. CPC C08L 77/02; C08K 3/22; C08K 7/14; C08K 2003/026; C08K 2003/2224; C08L 2201/02; C08L 2203/20; C08L 2310/00

(57) ABSTRACT

The present invention relates to a polyamide composition, which comprises A) 20% to 90% by weight of an aliphatic polyamide having a melting temperature of no higher than 245° C. and an intrinsic viscosity in the range of 90 ml/g to 240 ml/g as measured according to ISO 307. B) 3% to 12% by weight of red phosphorus. C) 3% to 12% by weight of magnesium hydroxide. D) 3% to 12% by weight of an impact modifier, and E) 0 to 50% by weight of a reinforcing agent, each being based on the total weight of the polyamide composition, and also to use of the polyamide composition for producing plastic articles requiring thermal aging resistance at a high temperature.

### FIELD OF INVENTION

The present invention relates to a flame-retardant polyamide composition and use thereof in plastic articles requiring thermal aging resistance at a high temperature, particularly in plastic parts for E&E systems and battery systems of new electric vehicles.

### BACKGROUND OF THE INVENTION

Flame retardant plastic materials are widely used for manufacturing parts in electrical and electronic (E&E) systems such as connector, miniature circuit breaker (MCB) and molded case circuit breaker (MCCB), and parts in new electric vehicle (NEV) battery systems such as connector, bus bar, battery cover and module holder. With the trend of miniaturizing parts in E&E systems and the trend of reducing weight of battery systems in new electric vehicles, the flame retardant materials need to have a higher flame retardancy performance, i.e., to meet the requirement of V0 in accordance with the UL94 standard at a thin thickness, for example a thickness of 1.5 millimeter (mm) or even 0.8 mm.

Moreover, plastic parts contacting an electric or electronic unit are generally working under a severe condition such as a high temperature (e.g., up to 160° C.), as the electric unit will generate lots of heat during operation. For that reason, the plastic parts are also required to have a high thermal aging resistance in addition to the high flame retardancy performance, to ensure long and safe service lifetime of the plastic parts.

As one of typical plastic materials, flame-retardant polyamide materials such as flame retardant PA66 are commonly used in E&E systems and NEV battery systems. However, such flame retardant polyamide materials need to comprise a special heat stabilizer to provide a thermal aging resistance at a high temperature (e.g., up to 160° C.). Such a special heat stabilizer contains metal ions combined with halide species. Undesirably, the metal ions and the halide species will result in corrosion on metallic parts and thus cause failure for electric units. It is important to develop a flame-retardant polyamide material which comprises no or a reduced amount of the special heat stabilizer, but could exhibit good thermal aging resistance performance.

Therefore, it will be desirable if a flame-retardant polyamide material meeting the flame retardancy requirement of V0 in accordance with the UL94 standard at a thin thickness, and at the same time exhibiting a good thermal aging resistance at a high temperature (e.g., 160° C.) could be found.

### SUMMARY OF THE INVENTION

It is an object of the present invention to provide a flame-retardant polyamide material for manufacturing articles or parts in E&E systems and NEV battery systems, which has a flame retardancy performance meeting the requirement of V0 in accordance with the UL94 standard at a thickness of 1.5 mm, preferably 0.80 mm, and at the same time exhibiting a good thermal aging resistance at a high temperature (e.g., 160° C.).

The object was achieved by a flame-retardant polyamide composition comprising a combination of red phosphorus, magnesium hydroxide and an impact modifier.

Flame-retardant polyamide compositions comprising a combination of red phosphorus and magnesium hydroxide as flame-retardant materials are known, for example from WO2021/122111A1. The patent application describes a flame-retardant polyamide composition for manufacturing industrial fans or blowers comprising, among others, a flame-retardant mixture comprising (i) 1.0 to 10.0 wt % of red phosphorus, and (ii) 1.0 to 10.0 wt % of magnesium hydroxide, based on the total weight of the flame-retardant polyamide composition, wherein the weight ratio between (i) and (ii) in the flame-retardant mixture is in the range of 1:5 to 5:1, and wherein the flame-retardant polyamide composition has a viscosity number of at least 114 ml/g, determined according to ISO 307. It is described in the patent application that the flame-retardant polyamide composition can meet the requirement of 5VA in accordance with the UL94 standard at a thickness of 2.0 mm. The thermal aging resistance at a high temperature which will be encountered during operation of E&E systems and NEV battery systems was not mentioned. It is known that the highest temperature that will be encountered for industrial fans or blowers is generally 80° C., and at most 110° C. rarely, which is much lower than the high temperature that will occur during the operation of E&E systems and NEV battery systems.

It was surprisingly found by the inventors that a flame-retardant polyamide composition having both desirable flame retardancy performance and good thermal aging resistance at a high temperature (e.g., 160° C.) can be provided by combining red phosphorus, magnesium hydroxide and an impact modifier in a polyamide matrix material in the way as described herein.

Accordingly, in the first aspect, the present invention relates to a flame-retardant polyamide composition comprising
A) 20% to 90% by weight of an aliphatic polyamide having a melting temperature of no higher than 245° C. and an intrinsic viscosity in the range of 90 ml/g to 240 ml/g as measured according to ISO 307,
B) 3% to 12% by weight of red phosphorus,
C) 3% to 12% by weight of magnesium hydroxide,
D) 3% to 12% by weight of an impact modifier, and
E) 0 to 50% by weight of a reinforcing agent, each being based on the total weight of the polyamide composition.

In the second aspect, the present invention relates to use of the flame-retardant polyamide composition as described herein for producing plastic articles requiring thermal aging resistance at a high temperature, particularly plastic parts in E&E systems and NEV battery systems.

In the third aspect, the present invention relates to articles produced using the flame-retardant polyamide composition as described herein, particularly plastic parts in E&E systems and NEV battery systems.

### DETAILED DESCRIPTION OF THE INVENTION

The present invention will be described in detail hereinafter. It is to be understood that the present invention can be embodied in many different ways and shall not be construed as limited to the embodiments set forth herein.

The singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements can be present. The expressions “consists of” or “consisting of” or cognates can be embraced within “comprises” or “comprising” or cognates.

Different aspects of the invention are defined in more detail. Each aspect so defined may be combined with any other aspect or aspects unless clearly indicated to the contrary. In particular, any feature indicated as being preferred may be combined with any other feature or features described generally or indicated as being preferred.

Herein, any reference to “some embodiments” means that a particular component, amount, composition or feature described in connection with the embodiments is included in some exemplary embodiments of the present invention. Thus, appearance of the phrase “in some embodiments” or similar phrases in various places throughout the description are not necessarily all referring to the same embodiments, but may. Furthermore, the component, amount, composition or feature may be combined in any suitable manners as would be apparent to the skilled person from the disclosure in more embodiments.

Herein, the terms “flame-retardant polyamide composition” and “polyamide composition” are interchangeably used to refer to the flame-retardant polyamide composition according to the present invention.

### Flame-Retardant Polyamide Composition

In the first aspect, the present invention provides a flame-retardant polyamide composition comprising
A) 20% to 90% by weight of an aliphatic polyamide having a melting temperature of no higher than 245° C. and an intrinsic viscosity in the range of 90 ml/g to 240 ml/g as measured according to ISO 307,
B) 3% to 12% by weight of red phosphorus,
C) 3% to 12% by weight of magnesium hydroxide,
D) 3% to 12% by weight of an impact modifier, and
E) 0 to 50% by weight of a reinforcing agent, each being based on the total weight of the polyamide composition.

### A) Polyamide

The polyamide composition according to the present invention comprises an aliphatic polyamide as component A).

Suitable polyamides for the present invention may have a melting temperature of no higher than 245° C., preferably no higher than 230° C., as measured by Differential Scanning calorimetry (DSC).

Moreover, suitable polyamides for the present invention may have an intrinsic viscosity in the range of 90 ml/g to 240 ml/g, preferably 100 ml/g to 220 ml/g, more preferably 130 ml/g to 200 ml/g, or in the range of 140 ml/g to 180 ml/g, as measured according to ISO 307.

Herein, the intrinsic viscosity number is determined from a 0.5 wt. % solution of the polyamide in 96 wt % sulfuric acid at 25° C., according to ISO 307.

The polyamides suitable for the present invention are aliphatic polyamides, which may for example be those derived from lactams, from amino acids, from ω-aminoalkylnitriles, from aliphatic dicarboxylic acids with aliphatic diamines, or from aliphatic dicarboxylic acid chlorides with aliphatic diamines.

Suitable lactams may be those having from 6 to 18 carbon atoms, preferably from 6 to 12 carbon atoms, for example caprolactam, caprylolactam, caprinolactam, undecanolactam, laurolactam, or any combinations thereof. Examples of the aliphatic polyamides which are derived from lactams may include, but are not limited to, polycaprolactam, polycaprylolactam, polycaprinolactam, polyundecanolactam, polylaurolactam or any combinations thereof.

Suitable amino acids may be those having from 6 to 18 carbon atoms, preferably from 6 to 12 carbon atoms, for example 6-aminoadipic acid, 9-aminononanoic acid, 10-aminodecanoic acid, 11-aminoundecanoic acid, 12-aminododecanoic acid, or any combinations thereof. Examples of the aliphatic polyamides which are derived from amino acids may include, but are not limited to, polycaprolactam, polycaprylolactam, polycaprinolactam, polyundecanolactam, polylaurolactam or any combinations thereof.

Suitable ω-aminoalkylnitriles may for example be aminocapronitrile, from which polycaprolactam may be obtained.

Suitable aliphatic dicarboxylic acids may be alkanedicarboxylic acids having 6 to 18 carbon atoms, preferably 6 to 12 carbon atoms, for example adipic acid, pimelic acid, suberic acid, azelaic acid, sebacic acid, undecanedioic acid, dodecandioic acid, or any combinations thereof.

Suitable aliphatic dicarboxylic acid chlorides may be alkanedicarboxylic chlorides having 6 to 18 carbon atoms, preferably 6 to 12 carbon atoms, for example adipoyl dichloride, heptanedioyl dichloride, suberoyl dichloride, azelaoyl dichloride, sebacoyl dichloride, undecanedioyl dichloride, lauroyl dichloride or any combinations thereof.

Suitable aliphatic diamines may be alkanediamines having 5 to 14 carbon atoms, preferably 6 to 12 carbon atoms, for example, 1,5-pentanediamine, 1,6-hexanediamine, 1,7-heptanediamine, 1,8-octanediamine, 1,9-nonanediamine, 1,10-decanediamine, 1,11-undecanediamine, 1,12-dodecanediamine, 1,13-tridecanediamine, 1,14-tetradecanediamine, or any combinations thereof.

Example of the aliphatic polyamides which are derived from aliphatic dicarboxylic acids with aliphatic diamines or from aliphatic dicarboxylic acid chlorides with aliphatic diamines may include, but are not limited to, PA 4.10, PA 5.10, PA 5.13, PA 6.8, PA 6.9, PA 6.10, PA 6.12, PA 6.13, PA 6.14, PA 6.18, PA 8.8, PA 8.10, PA 8.12, PA 10.6, PA 10.8, PA 10.10, PA 10.12, PA 10.14, PA 10.18, PA 12.10, PA 12.12, PA 12.14, PA 12.18.

In some embodiments, the aliphatic polyamide as the component A) may be selected from PA 6, PA 11, PA 12, PA 5.10, PA 6.8, PA 6.9, PA 6.10, PA 6.12, PA 10.6, PA 10.10, or any combinations thereof, among which PA 6 is more preferable.

In some further embodiments, the aliphatic polyamide as the component A) comprises PA 6 in a major amount, for example more than 50% by weight, 60% by weight or more, 75% by weight or more, or even 90% by weight or more, based on the total amount of the component A).

The aliphatic polyamide may be present in the polyamide composition according to the present invention in an amount of 20% to 90% by weight, for example from 25% to 60% by weight, preferably 35% to 60% by weight, based on the total weight of the polyamide composition.

The aliphatic polyamide disclosed herein should not be limited to the ones prepared from virgin crude oil monomers, and could be completely or at least partially biobased or derived from waste stream or recycling activities, i.e., the aliphatic polyamide used in the present application can be based on renewable materials, secondary raw materials or recycled raw materials. For example, PA6, PA6.8, PA6.9, PA6.10, PA6.12, PA10.6, PA10.10, PA11 and PA 12 used as component (A) in the present application could be prepared or obtained or derived from monomers that obtained in a re-monomerisation processes.

### B) Red Phosphorus

The polyamide composition according to the present invention comprises red phosphorus as component B).

Red phosphorus is comprised in the polyamide composition according to the present invention as an inorganic flame-retardant agent as known in the art. Red phosphorus may be present in the polyamide composition according to the present invention in an amount of 3% to 12% by weight, for example 4% to 10% by weight, preferably 5% to 7% by weight, based on the total weight of the polyamide composition.

Red phosphorus may be used in a conventional form as the flame-retardant agent, such as masterbatch particles.

In some embodiments, the polyamide composition according to the present invention does not contain other flame retardants, in particular halogenated or non-halogenated nitrogen-based flame retardants.

It is to be understood that the amount of red phosphorus when mentioned herein is intended to refer to red phosphorus per se. The amount of any polymeric matrix in a red phosphorus masterbatch shall not be counted into the amount of red phosphorus as discussed for the component B).

### C) Magnesium Hydroxide

The polyamide composition according to the present invention comprises magnesium hydroxide as component C).

Magnesium hydroxide is comprised in the polyamide composition according to the present invention as a flame-retardant synergist as known in the art.

Magnesium hydroxide may be used in a conventional form such as powders, which may or may not have been surface treated with a surface treating agent. Examples of the surface treating agent may include, but are not limited to, higher fatty acids such as oleic acid and stearic acid or alkali metal salts thereof, silane coupling agents such as vinyl silanes and aminosilanes, titanate-containing coupling agents, aluminum containing coupling agents, and partially esterified products of orthophosphoric acid. The amount of the surface treating agent may be in the range of 0.1 to 10% by weight, based on the total weight of the magnesium hydroxide powders.

Preferably, magnesium hydroxide which have been surface treated with a silane coupling agent is comprised as a flame-retardant synergist in the polyamide composition according to the present invention.

Magnesium hydroxide may be present in the polyamide composition according to the present invention in an amount of 3% to 12% by weight, for example 4% to 8% by weight, preferably 4% to 7% by weight, based on the total weight of the polyamide composition.

In some embodiments, red phosphorus and magnesium hydroxide may be used at a weight ratio in the range of 1:5 to 5:1, for example 1:2 to 3:1, preferably 1:1 to 2:1.

In some further embodiments, the polyamide composition according to the present invention does not contain other flame-retardant synergist.

### D) Impact Modifier

The polyamide composition according to the present invention comprises an impact modifier as component D).

Impact modifiers are often also referred to as rubber or elastomeric polymer. Suitable impact modifiers include (i) olefinic rubbers; (ii) olefinic rubbers grafted with reactive carboxylic acids or with derivatives thereof; and (iii) copolymers based on olefinic and (meth)acrylic monomers or ionomers thereof.

Suitable impact modifiers may be olefinic rubbers which are known per se. The olefinic rubbers may be polyolefins comprising repeating units derived from one or more olefins having from 2 to 10 or more carbon atoms, for example ethylene-propylene (EPM) type rubbers and ethylene-propylene-diene (EPDM) type rubbers. Examples of diene monomers for EPDM type rubbers are conjugated dienes such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes such as 3-methyltricyclo[5.2.1.02.6]-3,8-decadiene, or any combinations thereof.

Suitable impact modifiers may also be olefinic rubbers grafted with reactive carboxylic acids or with derivatives thereof. The olefinic rubbers are as described above. Examples of the reactive carboxylic acids or derivatives thereof may include maleic acid, fumaric acid, itaconic acid, acrylic acid, methacrylic acid, crotonic acid, and a C₁₋₄-alkyl half ester of maleic acid, acid anhydrides, acid imide and epoxy functional esters such as glycidyl esters of above acids.

Suitable impact modifiers may also be copolymers based on olefinic and (meth)acrylic monomers. Such copolymers are generally derived from monomers comprising (a) 40% to 98% by weight of ethylene, butylene, propylene or any combinations thereof, (b) 0.1% to 40% by weight of one or more monomers selected from C₁₋₈-alkyl (meth)acrylates such as methyl, ethyl, propyl, isobutyl and tert-butyl (meth)acrylates, (c) 2% to 25% by weight of acrylic acid and or methacrylic acid, (d) 0.1% to 15% of one or more monomers selected from ethylenically unsaturated dicarboxylic acids, esters and acid anhydrides thereof, and epoxy-containing monomers. The ethylenically unsaturated dicarboxylic acids may for example include, but are not limited to maleic acid, fumaric acid and itaconic acid. The epoxy-containing monomers may for example be glycidyl esters of ethylenically unsaturated carboxylic acids, particularly (meth)acrylate, such as glycidyl acrylate and glycidyl methacrylate.

It will be understood that the rubbers or elastomeric polymers as described hereinabove as the impact modifiers may have been neutralized when carboxylic group-containing units are comprised therein, which will also be referred to as ionomers. For example, the ionomers may be formed by partially or fully neutralization of the carboxylic group-containing units with metal ions selected from zinc, magnesium, manganese or mixtures thereof, alone or in combination with sodium or lithium ions.

In some embodiments, the polyamide composition according to the present invention comprises a copolymer of 40% to 98% by weight of ethylene, 10% to 40% by weight of n-butyl acrylate, 1% to 10% by weight of acrylic acid, and 0.1% to 5% by weight of maleic anhydride as an impact modifier. An Example of such a copolymer obtainable as Lupolen® KR 1270 from BASF SE.

The impact modifier may be present in the polyamide composition according to the present invention in an amount of 3% to 12% by weight, for example 5% to 10% by weight, preferably 6% to 8% by weight, based on the total weight of the polyamide composition.

### E) Reinforcing Agent

Optionally, the polyamide composition according to the present invention may further comprise a reinforcing agent as the component E), which may be of various types without particular restrictions, such as fiber, whisker, flake and particles. Useful reinforcing agents may be particularly selected from fibrous reinforcing agents and particulate fillers.

Examples of the fibrous reinforcing agents may include, but are not limited to metal fibers such as brass fibers, stainless steel fibers, steel fibers, metalized inorganic fibers, metalized synthetic fibers, glass fibers, carbon fibers, boron fibers, asbestos fibers, ceramic fibers, mineral fibers, basalt fibers, kenaf fibers, jute fibers, bamboo fibers, flax fibers, hemp fibers, bagasse fibers, cellulosic fibers, sisal fibers, and coir fibers. Preferably, the fibrous reinforcing agents may be selected from metalized synthetic fibers, glass fibers, carbon fibers, ceramic fibers, mineral fibers, basalt fibers, kenaf fibers and jute fibers, among which glass fibers and carbon fibers are more preferable.

There is no particular restriction to the fiber length and the fiber diameter of the fibrous reinforcing agent. For example, chopped fibers having a length in the range of from 1 to 10 mm, preferably from 2 to 6 mm, or continuous fibers may be used as starting material of the reinforcing agent. The fibers will be broken down during processing, for example kneading the polyamide composition, to a length of a few hundreds of microns as present in the obtained moldings. The fiber diameter is generally in the range of from 3 to 20 μm, preferably from 7 to 13 μm.

Examples of the cross-sectional shape of the fibrous reinforcing agent include for example circle, rectangle, ellipse, and other non-circular shapes, among which circle shape is especially preferred. The fibrous reinforcing agent may have a cross section with an aspect ratio in the range of from 1:1 to 5:1.

Glass fibers are particularly useful as the fibrous reinforcing agent for the present invention. The glass fibers may have been surface-treated by a silane coupling agent, such as vinylsilane-based coupling agents, acrylic silane-based coupling agents, epoxysilane-based coupling agents and aminosilane-based coupling agents, preferable aminosilane-based coupling agents. The silane coupling agent may be dispersed in a sizing agent. Examples of the sizing agents are acrylic compounds, acrylic/maleic derivative modified compounds, epoxy compounds, urethane compounds, urethane/maleic derivative modified compounds and urethane/amine modified compounds.

Particulate fillers may be organic or inorganic fillers and have a variety of particle sizes, ranging from particles in dust form to coarse particles. Examples of materials that may be used as inorganic particulate fillers include, but are not limited to kaolin, chalk, wollastonite, talc, calcium carbonate, silicates, titanium dioxide, zinc oxide, graphite, mica, vermiculite, montmorillonite, and glass particles (e.g., glass beads).

In some embodiments, the reinforcing agent as the component B) is selected from glass fibers. The glass fibers may be for example E-glass fibers, A-glass fibers, D-glass fibers, AR-glass fibers, C-glass fibers and S-glass fibers, or any other high modulus or high strength glass fibers such as M-glass fibers and HMG glass fibers.

The reinforcing agent, if comprised, may be present in the polyamide composition according to the present invention in an amount of from 10% to 50% by weight, preferably from 15% to 50% by weight, more preferably from 20% to 40% by weight, based on the total weight of the polyamide composition.

The reinforcing agents as component (E) disclosed herein can also be based on renewable materials, secondary raw materials or recycled raw materials. For example, the glass fibers used herein can be recycled glass fibers, or renewable glass fibers obtained from conventional recycling treatment process.

### F) Additional Additives

The polyamide composition according to the present invention may optionally comprise at least one additional additive, for example, stabilizers, lubricants, colorants, release agents, anti-dripping agents, compatibilizing agents, plasticizers, surfactants, nucleating agents, coupling agents, antimicrobial agents, antistatic agents, and any combinations thereof.

The at least one additional additive, if comprised, may be present in conventional amounts. For example, the polyamide composition may comprise the at least one additional additive in an amount of from 0.01% to 15% by weight, based on the total weight of the polyamide composition.

### Stabilizers

The polyamide composition may for example comprise a stabilizer. Suitable stabilizers may include, but are not limited to, organic stabilizers such as phosphite stabilizers, hindered phenol stabilizers, hindered amine stabilizers, oxanilide stabilizers, organic sulfur stabilizers and secondary aromatic amine stabilizers; and inorganic stabilizers such as combinations of copper compound and halide, and inorganic phosphorus-containing stabilizers.

Organic phosphite stabilizers include, for example, distearylpentaerythritol diphosphite, di-nonylphenylpentaerythritol diphosphite, bis(2,4-di-t-butylphenyl)pentaerythritol diphosphite, bis(2,6-di-t-butyl-4-methylphenyl)pentaerythritol diphosphite, bis(2,6-di-t-butyl-4-ethylphenyl)pentaerythritol diphosphite, bis(2,6-di-t-butyl-4-isopropylphenyl)pentaerythritol diphosphite, bis(2,4,6-tri-t-butylphenyl)pentaerythritol diphosphite, bis(2,6-di-t-butyl-4-sec-bu-tylphenyl)pentaerythritol diphosphite, bis(2,6-di-t-butyl-4-t-octylphenyl)pentaerythritol diphosphite, bis(2,4-dicumylphenyl)pentaerythritol diphosphite, tris(2,4-di-tert-butylphenyl) phosphite, triphenyl phosphite, diethyl 3,5-di-tert-butyl-4-hydroxybenzyl phosphate, and tetrakis(2,4-di-tert-butylphenyl)-4,4′-bisphenylene phosphonite.

Hindered phenol stabilizers include, for example, N,N′-hexane-1,6-diyl bis(3-(3,5-di-tert-butyl-4-hydroxyphenyl) propionamide), 4,6-bis(octylthiomethyl)-o-cresol, octyl 3,5-di-tert-butyl-4-hydroxyhydrocinnamate, 3,5-bis(1,1-dimethylethyl)-4-hydroxybenzenepropanoic acid C₇₋₉-branched alkyl ester, 2,4-bis[(dodecylthio)methyl]-o-cresol, pentaerythritol tetrakis(3-(3,5-di-tert-butyl-4-hydroxyphenyl) propionate), triethylene glycol bis[3-(3-tert-butyl-5-methyl-4-hydroxyphenyl) propionate], 2,4-bis(n-octylthio)-6-(4-hydroxy-3,5-di-tert-butylanilino)-1,3,5-triazine, tris-(3,5-di-tert-butyl-4-hydroxybenzyl) isocyanurate, 2,2-thiodiethylene bis[3-(3,5-di-tert-butyl-4-hydroxyphenyl) propionate], 4,4′-butylidene bis-(3-methyl-6-tert-butylphenol), octadecyl-3-(3,5-di-tert-butyl-4-hydroxyphenyl) propionate, 1,3,5-trimethyl-2,4,6-tris(3,5-di-tert-butyl-4-hydroxybenzyl)benzene, hexamethylene bis[3-3,5-di-tert-butyl-4-hydroxyphenyl]propionate] and calcium bis[monoethyl(3,5-di-tert-butyl-4-hydroxybenzyl)phosphonate], more preferably N,N′-hexane-1,6-diyl bis(3-(3,5-di-tert-butyl-4-hydroxyphenyl-propionamide.

Hindered amine stabilizers include, for example, 4-acetoxy-2,2,6,6-tetramethylpiperidine, 4-stearoyloxy-2,2,6,6-tetramethylpiperidine, 4-acryloyloxy-2,2,6,6-tetramethylpiperidine, 4-phenylacetoxy-2,2,6,6-tetramethylpiperidine, 4-benzoyloxy-2,2,6,6-tetramethylpiperidine, 4-methoxy-2,2,6,6-tetramethylpiperidine, 4-stearyloxy-2,2,6,6-tetramethylpiperidine, 4-cyclohexyloxy-2,2,6,6-tetramethylpiperidine, 4-benzyloxy-2,2,6,6-tetramethylpiperidine, 4-phenoxy-2,2,6,6-tetramethylpiperidine, 4-ethylcarbamoyloxy-2,2,6,6-tetramethylpiperidine, 4-cyclohexylcarbamoyloxy-2,2,6,6-tetramethylpiperidine, 4-phenylcarbamoyloxy-2,2,6,6-tetramethylpiperidine, bis(2,2,6,6-tetramethyl-4-piperidyl) carbonate, bis(2,2,6,6-tetramethyl-4-piperidyl) oxalate, bis(2,2,6,6-tetramethyl-4-piperidyl) malonate, bis(2,2,6,6-tetramethyl-4-piperidyl) sebacate, bis(2,2,6,6-tetramethyl-4-piperidyl) adipate, bis(2,2,6,6-tetramethyl-4-piperidyl) terephthalate, 1,2-bis(2,2,6,6-tetramethyl-4-piperidyloxy) ethane, α,α′-bis(2,2,6,6-tetramethyl-4-piperidyloxy)-p-xylene, bis(2,2,6,6-tetramethyl-4-piperidyltolylene)-2,4-dicarbamate, bis(2,2,6,6-tetramethyl-4-piperidyl) hexamethylene-1,6-dicarbamate, tris(2,2,6,6-tetramethyl-4-piperidyl)benzene-1,3,5-tricarboxylate, tris(2,2,6,6-tetra-methyl-4-piperidyl)benzene-1,3,4-tricarboxylate, 1-[2-{3-(3,5-di-t-butyl-4-hydroxyphenyl) propio-nyloxy}butyl]-4-[3-(3,5-di-t-butyl-4-hydroxyphenyl) propionyloxy]-2,2,6,6-tetramethylpiperidine, the condensation product of 1,2,3,4-butanetetracarboxylic acid and 1,2,2,6,6-pentamethyl-4-pi-peridinol and β,β,β′,β′-tetramethyl-3,9-[2,4,8,10-tetraoxaspiro(5,5)undecane]diethanol, the polycondensation product of dimethyl succinate and 1-(2-hydroxyethyl)-4-hydroxy-2,2,6,6-tetra-methylpiperidine, and 1,3-benzenedicarboxamide-N,N′-bis(2,2,6,6-tetramethyl-4-piperidyl).

Oxanilide stabilizers include 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl) oxanilide, 2-ethoxy-5-tert-butyl-2′-ethoxanilide, and mixtures thereof with 2-ethoxy-2′-ethyl-5,4′-di-tert-butoxanilide, mixtures of o- and p-methoxy-disubstituted oxanilides, mixtures of o- and p-ethoxy-disubstituted oxanilides.

Organic sulfur stabilizers include, for example, organic thioate compounds such as didodecyl thiodipropionate, ditetradecyl thiodipropionate, dioctadecyl thiodipropionate, pentaerythritol tetrakis(3-dodecylthiopropionate) and thiobis(N-phenyl-β-naphthylamine); mercaptobenzimidazole compounds such as 2-mercaptobenzothiazole, 2-mercaptobenzimidazole, 2-mercap-tomethylbenzimidazole and metal salts of 2-mercaptobenzimidazole; dithiocarbamate compounds such as metal salts of diethyldithiocarbamic acid and metal salts of dibutyldithiocarbamic acid; and thiourea compounds such as 1,3-bis(dimethylaminopropyl)-2-thiourea and tributylthiourea; and tetramethylthiuram monosulfide, tetramethylthiuram disulfide, nickel dibutyl dithiocarbamate, nickel isopropyl xanthate, and trilauryl trithiophosphite.

Secondary aromatic amine stabilizers include, for example, compounds having a diphenylamine skeleton such as p,p′-dialkyldiphenylamine wherein the alkyl group contains 8 to 14 carbon atoms, octylated diphenylamine, 4,4′-bis(α,α-dimethylbenzyl)diphenylamine, p-(p-toluenesulfonylamide) diphenylamine, N,N′-diphenyl-p-phenylenediamine, N-phenyl-N′-isopropyl-p-phenylenediamine, N-phenyl-N′-(1,3-dimethylbutyl)-p-phenylenediamine and N-phenyl-N′-(3-methacryloyloxy-2-hydroxypropyl)-p-phenylenediamine; compounds having a phenylnaphthylamine skeleton such as N-phenyl-1-naphthylamine and N,N′-di-2-naphtyl-p-phenylenediamine; and compounds having a dinaphthyl-amine skeleton such as 2,2′-dinaphthylamine, 1,2′-dinaphthylamine and 1,1′-dinaphthylamine.

Inorganic stabilizers include, for example, copper/halide based stabilizers and inorganic phosphorus-containing stabilizers. The copper/halide based stabilizers generally comprise a copper compound and an alkali metal halide. The copper compound may be copper (I) oxide, copper (II) oxide, copper (I) salt such as cuprous acetate, cuprous stearate, or a cuprous complex such as copper acetylacetonate, a cuprous halide or the like. The alkali metal halide may preferably be bromides and iodides of lithium, sodium and potassium. Examples of the combination of a copper compound and a halide may be the combination of CuI and KI. The inorganic phosphorus-containing stabilizers are for example phosphate, phosphite and hypophosphite stabilizers, particularly alkali metal phosphates, phosphites and hypophosphites.

Further inorganic stabilizers may include acid scavengers based on hydrotalcites or oxides or hydroxides or salts of zinc or an alkaline earth metal. Examples of the acid scavengers include natural or synthetic hydrotalcites, ZnO, Zn borate, Zn stannate, MgO, Mg(OH)₂, ZnCO₃, basic ZnCO₃, MgCO₃ and CaCO₃.

The stabilizer, if comprised, may be present in an amount of from 0.01 to 5% by weight, for example 0.01 to 3% by weight, or 0.01 to 2% by weight, based on the total weight of the polyamide composition.

In some embodiments, the polyamide composition comprises a copper/halide based stabilizer in an amount of no higher than 0.15% by weight, no higher than 0.1% by weight, or no higher than 0.01% by weight, based on the total weight of the polyamide composition. Preferably, the polyamide composition does not comprise a copper/halide based stabilizer.

### Lubricant

The polyamide composition may for example comprise a lubricant. Suitable lubricants may be selected from esters or amides of saturated or unsaturated aliphatic carboxylic acids having from 10 to 40, preferably from 16 to 22 carbon atoms with saturated aliphatic alcohols or amines which comprise from 2 to 40, preferably from 2 to 6 carbon atoms.

The carboxylic acids may be mono- or dibasic, for example pelargonic acid, palmitic acid, lauric acid, margaric acid, dodecanedioic acid and behenic acid, particularly stearic acid, capric acid, and montanic acid (a mixture of fatty acids having from 30 to 40 carbon atoms).

The aliphatic alcohols may be mono- to tetra-hydric, for example n-butanol, n-octanol, stearyl alcohol, ethylene glycol, propylene glycol, neopentyl glycol and pentaerythritol, preferably glycerol and pentaerythritol.

The aliphatic amines may be mono- to tri-functional, for example stearylamine, ethylenediamine, propylenediamine, hexamethylenediamine and di(6-aminohexyl)amine, preferably ethylenediamine and hexamethylenediamine.

Preferable esters or amides are N,N′-ethylene di(stearamide), glycerol distearate, glycerol tristearate, glycerol monopalmitate, glycerol trilaurate, glycerol monobehenate and pentaerythritol tetrastearate, among which N,N′-ethylene di(stearamide) is particularly preferable as a lubricant in the polyamide composition according to the present invention.

Other lubricants may be long-chain fatty acids (e.g., stearic acid or behenic acid), salts thereof (e.g., Ca stearate or Zn stearate), or montan waxes (mixtures of straight-chain, saturated carboxylic acids having chain lengths of from 28 to 32 carbon atoms), Ca montanate or Na montanate, and also low-molecular-weight polyethylene waxes and low-molecular-weight polypropylene waxes.

The lubricant, if comprised, may be present in an amount of from 0.01% to 2% by weight, for example from 0.1 to 1% by weight, or from 0.2 to 0.8% by weight, based on the total weight of the polyamide composition.

### Formulations

It will be understood that the any options with respect to species and/or amounts as described herein generally or with preference for the components A), B), C), D), E) and F) may be combined in any way without a restriction. For example, a combination of a general range of the amount of one component with any preferable ranges of the amounts of other components, or a combination of a preferable range of the amount of one component with general ranges of the amounts of the other components, and so on are included in the present invention.

Following embodiments will be described as examples of the formulations of the polyamide composition according to the present invention.

In some embodiments, the polyamide according to the present invention comprises
A) 25% to 60% by weight of an aliphatic polyamide having a melting temperature of no higher than 245° C. and an intrinsic viscosity in the range of 90 ml/g to 240 ml/g as measured according to ISO 307,
B) 4% to 10% by weight of red phosphorus,
C) 4% to 8% by weight of magnesium hydroxide,
D) 5% to 10% by weight of an impact modifier, and
E) optionally, 10% to 50% by weight of a reinforcing agent, each being based on the total weight of the polyamide composition.

In some further embodiments, the polyamide according to the present invention comprises
A) 35% to 60% by weight of an aliphatic polyamide having a melting temperature of no higher than 245° C. and an intrinsic viscosity in the range of 90 ml/g to 240 ml/g as measured according to ISO 307,
B) 5% to 7% by weight of red phosphorus,
C) 4% to 7% by weight of magnesium hydroxide,
D) 6% to 8% by weight of an impact modifier, and
E) optionally, 15% to 50% by weight by weight of a reinforcing agent,
each being based on the total weight of the polyamide composition.

In yet further embodiments, the polyamide according to the present invention comprises
A) 35% to 60% by weight of an aliphatic polyamide having a melting temperature of no higher than 245° C. and an intrinsic viscosity in the range of 100 ml/g to 220 ml/g as measured according to ISO 307,
B) 5% to 7% by weight of red phosphorus,
C) 4% to 7% by weight of magnesium hydroxide,
D) 6% to 8% by weight of an impact modifier, and
E) optionally, 20% to 40% by weight of a reinforcing agent, each being based on the total weight of the polyamide composition.

In some particular embodiments, the polyamide according to the present invention comprises
A) 35% to 60% by weight of an aliphatic polyamide having a melting temperature of no higher than 230° C. and an intrinsic viscosity in the range of 130 ml/g to 200 ml/g as measured according to ISO 307,
B) 5% to 7% by weight of red phosphorus,
C) 4% to 7% by weight of magnesium hydroxide,
D) 6% to 8% by weight of an impact modifier, comprising a copolymer of 40% to 98% by weight of ethylene, 10% to 40% by weight of n-butyl acrylate, 1% to 10% by weight of acrylic acid, and 0.1% to 5% by weight of maleic anhydride or an ionomer thereof, and E) optionally, 20% to 40% by weight of a reinforcing agent, each being based on the total weight of the polyamide composition.

In some other particular embodiments, the polyamide according to the present invention comprises
A) 35% to 60% by weight of an aliphatic polyamide having a melting temperature of no higher than 230° C. and an intrinsic viscosity in the range of 140 ml/g to 180 ml/g as measured according to ISO 307,
B) 5% to 7% by weight of red phosphorus,
C) 4% to 7% by weight of magnesium hydroxide,
D) 6% to 8% by weight of an impact modifier, comprising a copolymer of 40% to 98% by weight of ethylene, 10% to 40% by weight of n-butyl acrylate, 1% to 10% by weight of acrylic acid, and 0.1% to 5% by weight of maleic anhydride or an ionomer thereof, and
E) optionally, 20% to 40% by weight of a reinforcing agent, each being based on the total weight of the polyamide composition.

In some exemplary particular embodiments, the polyamide according to the present invention comprises
A) 35% to 60% by weight of PA6,
B) 5% to 7% by weight of red phosphorus,
C) 4% to 7% by weight of magnesium hydroxide,
D) 6% to 8% by weight of an impact modifier, comprising a copolymer of 40% to 98% by weight of ethylene, 10% to 40% by weight of n-butyl acrylate, 1% to 10% by weight of acrylic acid, and 0.1% to 5% by weight of maleic anhydride or an ionomer thereof, and
E) optionally, 20% to 40% by weight of a reinforcing agent, each being based on the total weight of the polyamide composition.

In any embodiments as described hereinabove, the components B), C) and D) are preferably present in a total amount of no higher than 30% by weight, based on the total weight of the polyamide composition.

The polyamide composition according to the present invention may be processed by any conventional methods without particular restrictions. The method comprises at least the step of compounding the components as described herein. Compounding per se is a technique which is well known to the skilled person in the art of polymer processing and manufacturing, and consists of preparing plastic formulations by mixing and/or blending the components in a molten state. The mixing may be carried out at a rotational speed ranging between 200 rpm to 320 rpm. It is understood in the art that compounding is distinct from blending or mixing processes conducted at temperatures lower than a temperature at which the components become molten. Compounding may, for example, be used to form a masterbatch composition. Compounding may, for example, involve adding a masterbatch composition to a polymer to form a further polymer composition. The compounding may be carried out a temperature of from 220° C. to 350° C.

The polyamide composition may be shaped into a desired form of articles, for example by molding such as compression molding, injection molding, stretch blow molding, injection blow molding and hollow molding, extrusion, casting or thermoforming.

### Use of the Polyamide Composition

As found by the inventors surprisingly, the polyamide composition according to the present invention could exhibit superior heat-aging resistance at high temperature without using special heat stabilizers while meeting the flame retardancy requirement of V0 in accordance with the UL94 standard.

Accordingly, in the second aspect, the present invention provides use of the polyamide composition as described herein for producing plastic articles requiring thermal aging resistance at a high temperature, e.g., 160° C. or higher.

Particularly, the present invention provides use of the polyamide composition as described herein for producing the plastic parts in E&E systems and NEV battery systems.

### Articles

In the third aspect, the present invention relates to articles produced using the polyamide composition as described herein. The articles produced using the polyamide composition are useful in various applications, particularly in E&E systems and NEV battery systems.

For example, the articles produced using the polyamide composition may be connectors, miniature circuit breakers and molded case circuit breakers in E&E systems, and connectors, bus bars, battery covers and module holders in the new electric vehicle (NEV) battery systems.

### Embodiments

Various embodiments are listed below. It will be understood that the embodiments listed below can be combined with all aspects and other embodiments in accordance with the scope of the invention.
1. A polyamide composition, which comprises
   A) 20% to 90% by weight of an aliphatic polyamide having a melting temperature of no higher than 245° C. and an intrinsic viscosity in the range of 90 ml/g to 240 ml/g as measured according to ISO 307,
   B) 3% to 12% by weight of red phosphorus,
   C) 3% to 12% by weight of magnesium hydroxide,
   D) 3% to 12% by weight of an impact modifier, and
   E) 0 to 50% by weight of a reinforcing agent, each being based on the total weight of the polyamide composition.
2. The polyamide composition according to Embodiment 1, wherein the aliphatic polyamide has a melting temperature of no higher than 230° C.
3. The polyamide composition according to any of preceding Embodiments, wherein the aliphatic polyamide is selected from PA 4.10, PA 5.10, PA 5.13, PA 6.8, PA 6.9, PA 6.10, PA 6.12, PA 6.13, PA 6.14, PA 6.18, PA 8.8, PA 8.10, PA 8.12, PA 10.6, PA 10.8, PA 10.10, PA 10.12, PA 10.14, PA 10.18, PA 12.10, PA 12.12, PA 12.14, PA 12.18 or any combinations thereof.
4. The polyamide composition according to any of preceding Embodiments, wherein the aliphatic polyamide comprises PA 6 in an amount of more than 50% by weight, 60% by weight or more, 75% by weight or more, or even 90% by weight or more, based on the total amount of the aliphatic polyamide.
5. The polyamide composition according to Embodiment 4, wherein the aliphatic polyamide as the component A) is PA 6.
6. The polyamide composition according to any of preceding Embodiments, wherein the impact modifier is selected from (i) olefinic rubbers, (ii) olefinic rubbers grafted with reactive carboxylic acids or with derivatives thereof, (iii) copolymers based on olefinic and (meth)acrylic monomers or ionomers thereof, or any combinations thereof.
7. The polyamide composition according to Embodiment 6, wherein the impact modifier is selected from copolymers based on olefinic and (meth)acrylic monomers or ionomers thereof.
8. The polyamide composition according to Embodiment 7, wherein the copolymers based on olefinic and (meth)acrylic monomers comprise units of (a) 40% to 98% by weight of ethylene, butylene, propylene or any combinations thereof, (b) 0.1% to 40% by weight of one or more monomers selected from C₁₋₈-alkyl (meth)acrylates such as methyl, ethyl, propyl, isobutyl and tert-butyl (meth)acrylates, (c) 2% to 25% by weight of acrylic acid and or methacrylic acid, (d) 0.1% to 15% of one or more monomers selected from ethylenically unsaturated dicarboxylic acids, esters and acid anhydrides thereof, and epoxy-containing monomers.
9. The polyamide composition according to Embodiment 8, where the ethylenically unsaturated dicarboxylic acids are selected from maleic acid, fumaric acid and itaconic acid.
10. The polyamide composition according to Embodiment 9, wherein the impact modifier is selected from copolymers of 40% to 98% by weight of ethylene, 10% to 40% by weight of n-butyl acrylate, 1% to 10% by weight of acrylic acid, and 0.1% to 5% by weight of maleic anhydride.
11. The polyamide composition according to any of preceding Embodiments, wherein the component B) comprises a glass fiber.
12. The polyamide composition according to any of preceding Embodiments, wherein the component A) is present in an amount of 25% to 60% by weight, preferably 35% to 60% by weight.
13. The polyamide composition according to any of preceding Embodiments, wherein the component B) is present in an amount of 4% to 10% by weight, preferably 5% to 7% by weight.
14. The polyamide composition according to any of preceding Embodiments, wherein the component C) is present in an amount of 4% to 8% by weight, preferably 4% to 7% by weight.
15. The polyamide composition according to any of preceding Embodiments, wherein the component D) is present in an amount of 5% to 10% by weight, preferably 6% to 8% by weight.
16. The polyamide composition according to any of preceding Embodiments, wherein the component E) is optionally present in an amount of from 10% to 50% by weight, preferably from 15% to 50% by weight, more preferably from 20% to 40% by weight.
17. The polyamide composition according to any of preceding Embodiments, wherein the components B), C) and D) are present in a total amount of no higher than 30% by weight, based on the total weight of the polyamide composition.
18. Use of the polyamide composition according to any of preceding Embodiments for producing plastic articles requiring thermal aging resistance at a high temperature, for example 160° C. or higher.
19. The use of the polyamide composition according to Embodiment 18, for producing plastic parts in electrical and electronic systems and new electric vehicle battery systems.
20. Articles produced using the polyamide composition according to any of preceding Embodiments 1 to 17, particularly parts in electrical and electronic systems and new electric vehicle battery systems.
21. The articles according to Embodiment 20, which are connectors, miniature circuit breakers and molded case circuit breakers in electrical and electronic systems, and connectors, bus bars, battery covers and module holders in new electric vehicle battery systems.

### Examples

Aspects of the present invention will be more fully illustrated by the following examples, which are set forth to illustrate certain aspects of the present invention and are not to be construed as limiting thereof.

Materials

| Ingredient | Description |
|---|---|
| A/1 | PA 6.6, Ultramid ® A27 from BASF SE, with an |
| | intrinsic viscosity (IV) of 150 ml/g as measured |
| | as a 0.5% by weight solution in 96% by weight |
| | sulfuric acid at 25° C. in accordance with ISO 307 |
| | and a melting temperature of 260° C. as measured via DSC |
| A/2 | PA 6, Ultramid ® B27 from BASF SE, with an intrinsic |
| | viscosity (IV) of 150 ml/g as measured as a 0.5% by weight |
| | solution in 96% by weight sulfuric acid at 25° C. in |
| | accordance with ISO 307 and a melting temperature of |
| | 220° C. as measured via DSC |
| B/1 | Standard chopped glass fiber, NEG-T251H from Nippon |
| | Electric Glass Co., with a length of 4.5 mm and a |
| | diameter of 10 μm |
| C/1 | 50 wt % Red phosphorus masterbatch in PA 6 matrix, |
| | FR9950T from Tongcheng Shinde New Materials Co, Ltd., |
| | with an average particle size (D₅₀) of |
| | 20 to 25 um |
| D/1 | Magnesium hydroxide, amino silane coated, MAGNIFIN H-5 |
| | IV, from Huber, with an average particle size (D₅₀) |
| | of 1.4 to 2 um |
| E/1 | A copolymer of 59.8% by weight of ethylene, 35% by weight |
| | of n-butyl acrylate, 4.5% by weight of acrylic acid and |
| | 0.7% by weight of maleic anhydride, Lupolen ® KR1270 |
| | from BASF SE, with a melt index MFI (190/2.16) of 10 |
| | g/10 min |
| F/1 | Lubricant, Calcium stearate from Baerlocher, Ceasit AV Veg |
| F/2a | Antioxidant, Irganox ® 1098 from BASF, N,N′-hexane-1, |
| | 6-diyl bis(3-(3,5-di-tert-butyl-4-hydroxyphenyl)propionamide) |
| F/2b | Copper/halide based stabilizer, PB 201 lodide Stab from |
| | PolyAd Services, a combination of 80% KI, 10% Cul and |
| | 10% zinc stearate |
| F/2c | Copper/halide based stabilizer, BRUGGOLEN ® H3350 from |
| | Bruggemann Chemical, a combination of copper complex |
| | and KI |
| F/3 | Acid scavenger, 99.8% zinc oxide from Jiangsu Shenlong |
| | Zinc Industry Co., Ltd |
| F/4 | Black colorant masterbatch (MB), Colloids Ltd., polyamide 6 |
| | (PA6) with 30% carbon black |

### Measuring and Test Methods

(1) Flame retardancy performance was measured according to UL 94V (Underwriters Laboratories Inc., Standard of Safety, “Test for Flammability of Plastic Materials for Parts in Devices and Appliances”, pages 14 to 18, Northbrook 1998);
(2) Tensile strength, tensile modulus and tensile elongation were measured on the testing machine Z050 (Zwick Roell, Germany) according to ISO 527-2/1A;
(3) Notched Charpy impact strength was measured on the testing machine HIT25P (Zwick Roell, Germany) according to ISO 179/1eA;
(4) Unnotched Charpy impact strength was measured on the testing machine HIT25P (Zwick Roell, Germany), according to ISO 179/1eU; and
(5) Tensile strength retention was calculated in accordance with the following equation,

Tensile strength retention=Tensile Strength after Aging/Initial Tensile Strength×100%.

### Preparation of Test Specimens

Test Specimens were prepared in accordance with the formulations as shown in Table 1 by granulating and molding.

The granulating process includes
(1) Blending all ingredients except glass fiber and red phosphorous in a high-speed mixer,
(2) Feeding the mixture from (1) into the throat zone in a twin screw extruder,
(3) Feeding glass fiber into the extruder via a side fiber feeder,
(4) Feeding red phosphorous masterbatch into the extruder via a side powder feeder,
(5) Cutting the extrudate to pellets through twin screw extruder granulation,
wherein the screw diameter is 26 mm, the screw speed is 300 rpm to 500 rpm, and the throughput is 25 to 35 kg/h and melt temperature is 280° C.

Then, test specimens for the tensile tests were produced by molding the obtained pellets in accordance with ISO 527-2:/1993, and test specimens for the impact resistance tests were produced by molding the obtained pellets in accordance with ISO 179-2.

Test specimens for the flame retardancy performance test were prepared by molding the obtained pellets to provide sheets having a size of 127 mm×12.7 mm×0.80 mm (or 1.50 mm) (length×width×thickness). The flame retardancy of the molding compositions was determined firstly by the UL 94V method.

### Aging Conditions

Heat aging tests were conducted in a standard laboratory oven at elevated temperatures in an atmosphere of air.

The formulations and test results are summarized in Table 1 below. The amounts of the ingredients are given in percentages by weight.

TABLE 1

| | Comp. | Comp. | Comp. | Comp. | Ex. | Ex. | Comp. | Ex. | Comp. | Comp. | Ex. | Ex. |
|---|---|---|---|---|---|---|---|---|---|---|---|---|
| Ingredient | 1 | 2 | 3 | 4 | 1 | 2 | 5 | 3 | 6 | 7 | 4 | 5 |
| A/1, PA 6.6 | 51.27 | 49.27 | | | | | | | | | | |
| A/2, PA 6 | | | 51.27 | 49.27 | 47.27 | 45.27 | 49.27 | 47.27 | 51.12 | 51.12 | 45.12 | 45.12 |
| B/1, GF | 25 | 25 | 25 | 25 | 25 | 25 | 25 | 25 | 25 | 25 | 25 | 25 |
| C/1, red P | 13 | 13 | 13 | 13 | 13 | 13 | 13 | 13 | 13 | 13 | 13 | 13 |
| D/1, Mg(OH)₂ | 0 | 2 | 0 | 2 | 4 | 6 | 6 | 6 | 0 | 0 | 6 | 6 |
| E/1, IM | 6 | 6 | 6 | 6 | 6 | 6 | 2 | 4 | 6 | 6 | 6 | 6 |
| F/1 | 0.35 | 0.35 | 0.35 | 0.35 | 0.35 | 0.35 | 0.35 | 0.35 | 0.35 | 0.35 | 0.35 | 0.35 |
| F/2a | 0.35 | 0.35 | 0.35 | 0.35 | 0.35 | 0.35 | 0.35 | 0.35 | 0.35 | 0.35 | 0.35 | 0.35 |
| F/2b, copper/halide | | | | | | | | | 0.15 | | 0.15 | |
| F/2c, copper/halide | | | | | | | | | | 0.15 | | 0.15 |
| F/3 | 0.7 | 0.7 | 0.7 | 0.7 | 0.7 | 0.7 | 0.7 | 0.7 | 0.7 | 0.7 | 0.7 | 0.7 |
| F4 | 3.33 | 3.33 | 3.33 | 3.33 | 3.33 | 3.33 | 3.33 | 3.33 | 3.33 | 3.33 | 3.33 | 3.33 |
| Compounding | OK | Failed | OK | OK | OK | OK | OK | OK | OK | OK | OK | OK |

Dry, as-molded

| | | | | | | | | | | | | |
|---|---|---|---|---|---|---|---|---|---|---|---|---|
| UL94 at 0.80 mm | V0 | — | V2 | V2 | V0 | V0 | V2 | V2 | V2 | V2 | V0 | V0 |
| UL94 at 1.50 mm | V0 | — | V2 | V2 | V0 | V0 | V2 | V0 | V2 | V2 | V0 | V0 |
| Charpy unnotched impact strength, | 60 | — | 74 | 70 | 70 | 66 | 51 | 57 | 66 | 68 | 63 | 63 |
| kJ/m² | | | | | | | | | | | | |
| Charpy notched impact strength, | 9.0 | — | 10.0 | 9.8 | 10 | 8.9 | 7.8 | 8.3 | 9.5 | 9.8 | 8.8 | 8.5 |
| kJ/m² | | | | | | | | | | | | |
| Tensile modulus | 9290 | — | 8570 | 8640 | 8650 | 8580 | 9320 | 8980 | 8220 | 8110 | 8740 | 8670 |
| Tensile elongation at break, % | 3.0 | — | 3.4 | 3.3 | 3.4 | 3.2 | 2.6 | 2.9 | 3.3 | 3.0 | 2.9 | 3.1 |
| Tensile strength, MPa | 140 | — | 141 | 128 | 133 | 133 | 146 | 142 | 138 | 136 | 134 | 126 |

Tensile Properties, after aging for 1000 h at 160° C.

| | | | | | | | | | | | | |
|---|---|---|---|---|---|---|---|---|---|---|---|---|
| Tensile strength, MPa | 85 | — | 104 | 95 | 121 | 127 | — | — | 117 | 118 | 115 | 113 |
| Tensile strength retention, % | 61 | — | 74 | 74 | 91 | 96 | — | — | 85 | 87 | 86 | 90 |

Tensile Properties, after aging for 2000 h at 160° C.

| | | | | | | | | | | | | |
|---|---|---|---|---|---|---|---|---|---|---|---|---|
| Tensile strength, MPa | 70 | — | 65 | 56 | 94 | 112 | — | — | 103 | 101 | 112 | 109 |
| Tensile strength retention, % | 50 | — | 46 | 44 | 71 | 84 | — | — | 75 | 74 | 84 | 87 |

“—”: not determined;
“Comp.”: Comparative;
“Ex.”: Example

It was surprisingly found that the polyamide compositions according to the present invention (Ex. 1 to Ex. 5) exhibited significantly improved retention of mechanical performance after aging at a high temperature of 160° C., while meeting the flame retardancy requirement of UL94 V0 at a thickness of 1.5 mm, even at a thickness of 0.8 mm, compared with the polyamide compositions not according to the present invention (Comp. 1 to Comp. 7).

Also surprisingly, the polyamide compositions according to the present invention containing no copper/halide stabilizer could exhibit a thermal aging resistance even better than the polyamide compositions containing a copper/halide stabilizer (Ex. 2 vs. Ex. 4 and Ex. 5), which can be seen from the higher tensile strength retention after 1000 h aging and the comparable tensile strength retention after 2000 h aging. The polyamide composition according to the present invention allow to dispense the conventional copper/halide thermostabilizer or use it in significantly reduced amount, which will be greatly beneficial to plastic electric parts in terms of safe and long-term service thereof.

1.-21. (canceled)

22. A polyamide composition, which comprises
A) 20% to 90% by weight of an aliphatic polyamide having a melting temperature of no higher than 245° C. and an intrinsic viscosity in the range of 90 ml/g to 240 ml/g as measured according to ISO 307,
B) 3% to 12% by weight of red phosphorus,
C) 3% to 12% by weight of magnesium hydroxide,
D) 3% to 12% by weight of an impact modifier, and
E) 0 to 50% by weight of a reinforcing agent,
each being based on the total weight of the polyamide composition.

23. The polyamide composition according to claim 22, wherein the aliphatic polyamide has a melting temperature of no higher than 230° C.

24. The polyamide composition according to claim 22, wherein the aliphatic polyamide is selected from PA 4.10, PA 5.10, PA 5.13, PA 6.8, PA 6.9, PA 6.10, PA 6.12, PA 6.13, PA 6.14, PA 6.18, PA 8.8, PA 8.10, PA 8.12, PA 10.6, PA 10.8, PA 10.10, PA 10.12, PA 10.14, PA 10.18, PA 12.10, PA 12.12, PA 12.14, PA 12.18 or any combinations thereof.

25. The polyamide composition according to claim 22, wherein the aliphatic polyamide comprises PA 6 in an amount of more than 50% by weight, 60% by weight or more, 75% by weight or more, or even 90% by weight or more, based on the total amount of the aliphatic polyamide.

26. The polyamide composition according to claim 25, wherein the aliphatic polyamide as the component A) is PA 6.

27. The polyamide composition according to claim 22, wherein the impact modifier is selected from olefinic rubbers, olefinic rubbers grafted with reactive carboxylic acids or with derivatives thereof, copolymers based on olefinic and (meth)acrylic monomers or ionomers thereof, or any combinations thereof.

28. The polyamide composition according to claim 27, wherein the impact modifier is selected from copolymers based on olefinic and (meth)acrylic monomers or ionomers thereof.

29. The polyamide composition according to claim 28, wherein the copolymers based on olefinic and (meth)acrylic monomers comprise units of (a) 40% to 98% by weight of ethylene, butylene, propylene or any combinations thereof, (b) 0.1% to 40% by weight of one or more monomers selected from C₁₋₈-alkyl (meth)acrylates such as methyl, ethyl, propyl, isobutyl and tert-butyl (meth)acrylates, (c) 2% to 25% by weight of acrylic acid and or methacrylic acid, (d) 0.1% to 15% of one or more monomers selected from ethylenically unsaturated dicarboxylic acids, esters and acid anhydrides thereof, and epoxy-containing monomers.

30. The polyamide composition according to claim 29, wherein the ethylenically unsaturated dicarboxylic acids are selected from maleic acid, fumaric acid and itaconic acid.

31. The polyamide composition according to claim 30, wherein the impact modifier is selected from copolymers of 40% to 98% by weight of ethylene, 10% to 40% by weight of n-butyl acrylate, 1% to 10% by weight of acrylic acid, and 0.1% to 5% by weight of maleic anhydride.

32. The polyamide composition according to claim 22, wherein the component B) comprises a glass fiber.

33. The polyamide composition according to claim 22, wherein the component A) is present in an amount of 25% to 60% by weight.

34. The polyamide composition according to claim 22, wherein the component B) is present in an amount of 4% to 10% by weight.

35. The polyamide composition according to claim 22, wherein the component C) is present in an amount of 4% to 8% by weight.

36. The polyamide composition according to claim 22, wherein the component D) is present in an amount of 5% to 10% by weight.

37. The polyamide composition according to claim 22, wherein the component E) is optionally present in an amount of from 10% to 50% by weight.

38. The polyamide composition according to claim 22, wherein the components B), C) and D) are present in a total amount of no higher than 30% by weight, based on the total weight of the polyamide composition.

39. A method for producing plastic articles requiring thermal aging resistance at a high temperature, the method comprising using the polyamide composition according to claim 22 to produce the plastic articles.

40. The method according to claim 39, wherein the plastic articles are plastic parts in electrical and electronic systems and new electric vehicle battery systems.

41. The method according to claim 40, wherein the plastic articles are connectors, miniature circuit breakers and molded case circuit breakers in electrical and electronic systems, and connectors, bus bars, battery covers and module holders in new electric vehicle battery systems.
